(19) United States
(12) Patent Application Publication
(10) Pub. No.: US 2015/0177006 A1
(43) Pub. Date: Jun. 25, 2015

(54) SYSTEMS AND METHODS FOR CROWD CONGESTION REDUCTION AT VENUE LOCATIONS USING BEACONS

(71) Applicants: Egan Schulz, San Jose, CA (US); Michelle Serrano, San Jose, CA (US); Libo Su, San Jose, CA (US)

(72) Inventors: Egan Schulz, San Jose, CA (US); Michelle Serrano, San Jose, CA (US); Libo Su, San Jose, CA (US)

(21) Appl. No.: 14/136,195

(22) Filed: Dec. 20, 2013

(51) Int. Cl. G01C 21/34; H04W 4/02

(52) U.S. Cl. CPC G01C 21/34; H04W 4/02

(57) ABSTRACT

There are provided systems and method for crowd congestion reduction at venue locations using beacons. A venue may set up short range wireless beacons throughout the venue at locations corresponding to attractions, exhibits, rides, etc. The beacons may establish a connection with a user device held by a user when the user device comes into range of the beacon. Thus, a server for the venue may be updated with a total number of users at each of the beacons, and thus at each of the locations. The server may utilize this information to determine travel routes for users that minimize a number of users at each of the locations. The server may spread the users out through the venue's locations and thus allow each user to visit the locations with reduced crowd congestion. The travel route may be updated as the crowd of users move throughout the venue.

### TECHNICAL FIELD

The present application generally relates to crowd congestion reduction at venue locations using beacons and more specifically to providing short range wireless beacons throughout a location where crowds congregate and utilizing the beacons to direct traffic throughout the location by minimizing a number of persons at each of the beacons.

### BACKGROUND

Users may visit locations of frequent crowd congestion, such as amusement parks, museums, or other events at venues. Throughout the venue, various stations, exhibits, or attractions may draw user's attention and create crowd congestion, such as lines for amusement park rides or groups viewing exhibits. This crowd congestion can lead to certain users at the venue being unable to attend or view an attraction. Moreover, the crowd congestion can lead to safety concerns and make traveling through the venue more difficult. Some venues may provide maps that help users space out their attendance at various attractions, but without knowing crowd traffic patterns, users have no way of knowing whether an attraction will be too congested for a visit throughout the day. Other venues attempt to address the issue through scheduling of attraction times, time to wait before attending/viewing an attraction, and/or limited ticketing to the attraction, but these solutions offer limited information and may not direct crowds away from high interest attractions during particularly high congestion periods.

### BRIEF DESCRIPTION OF THE DRAWINGS

FIG. 1 is a block diagram of a networked system suitable for implementing the processes described herein, according to an embodiment;

FIG. 2A is an exemplary venue server including map information for a venue location, according to an embodiment;

FIG. 2B is an exemplary user device displaying a travel route and map for a venue location, according to an embodiment;

FIG. 3 is a flowchart of an exemplary process by a server for reducing crowd congestion at venue locations, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Various locations provide short range wireless communications with a user device, such as through Bluetooth Low Energy (BLE) beacon communications. These beacons may be set up at a location and communicate with the user device to alert users of check-in services through their user device. The beacons may provide additional functionality, such establishing a connection with a server entity to complete transactions, including check-in services. Additionally, the beacons may provide communication services to the user device directly, including information stored on the beacons, and/or information from a device or server corresponding to the beacon.

A venue, such as an amusement park, museum, stadium, or other location where crowds congregate, may offer check-in services with users to facilitate movement throughout the venue. The venue may utilize short range wireless beacons to communicate with mobile user devices of the users. The short range wireless beacons may employ BLE communications that emit a signal receivable by a user device. The communication may include an identifier for the beacon. A user device may passively monitor for BLE communications. When a user device detects the signal and verifies the identifier as belonging to the venue (e.g., a venue device and/or server), both the user device and the beacon may ramp up in power and establish a connection, where the connection may further enable the user device to communicate with the venue device/server. The beacon may be connected to a networked device at the venue, or the beacon may include network functionality to communicate with the venue server. Thus, the user may receive travel routes, maps, crowd congestion rates/numbers at attractions, and/or crowd traffic flow patterns throughout the venue.

Thus, wireless beacons may establish a communication channel with a user device that the user possesses. The wireless beacons may correspond to attractions at the venue, for example, the wireless beacon may be located at amusement park rides, exhibits, concession stands, restaurants, and similar locations. Establishment of a communication channel may trigger an application on the user device to check the user in to that location and receive mapping information for the venue, including travel routes throughout the venue. As a plurality of users check in to various locations throughout the venue, the venue server may determine a number of users at each of the plurality of beacons. The beacons may also determine when users leave a specific beacon location. Thus, the venue server contains data corresponding to crowd congestion rates/numbers at each of the attractions.

The server(s) may then determine a travel route for users throughout the venue. The venue server may determine a travel route for a user that minimizes the number of users at each of the locations. For example, if a first exhibit has 100 users checked-in to a beacon at the exhibit, but a second exhibit has only 25, the venue server may direct the user to second exhibit. The travel route may include a list of directions to each of the attractions. Thus, the user may later be directed to the first exhibit. When the user arrives at the first exhibit, the user may be checked-in again to a beacon at the first exhibit, thus tracking a number of users at each venue location in real time. Additionally, the venue server may provide an expected wait time at each location and an amount of time each user should spend at an exhibit to maximize both number of locations visited and minimize traffic at each location. If a user desires to stay at an exhibit for a longer period of time, the venue server may recalculate the travel route and expected wait times for the user and/or other users utilizing the check-in and mapping features of the venue server.

The user may receive additional information with the travel route. In certain embodiments, the venue server provides the user with the number of other users at each location as well as an expected wait time. Thus, even if the travel route recommends one location next, the user may choose another location based on distance, preference, etc. The travel route may be recalculated based on the deviation to the original travel route as well. The venue server may also update the user with changes to the number of users at each location, for example, real time updates of the number of users at each location. Where the venue server tracks the user traffic patterns, such as flow patterns of users to and from the locations, the user may also see the flow patterns in order to anticipate pathways, roads, etc. that may be congested. In certain embodiments, the user may transmit preferences for locations to visit and the venue server may account for the preferences when determining the travel route.

In other embodiments, the user may be able to hear or view specific audio or visual information based on the location of the user within the location, based on BLE location determination. For example, the user may be approaching or within a communication range of an exhibit, and upon detection, the user may be able to hear and/or see information related to the exhibit on the user's device. The wireless beacon may transmit the audio/visual data to the user device and/or the audio/visual data may be made available over a network for the user device.

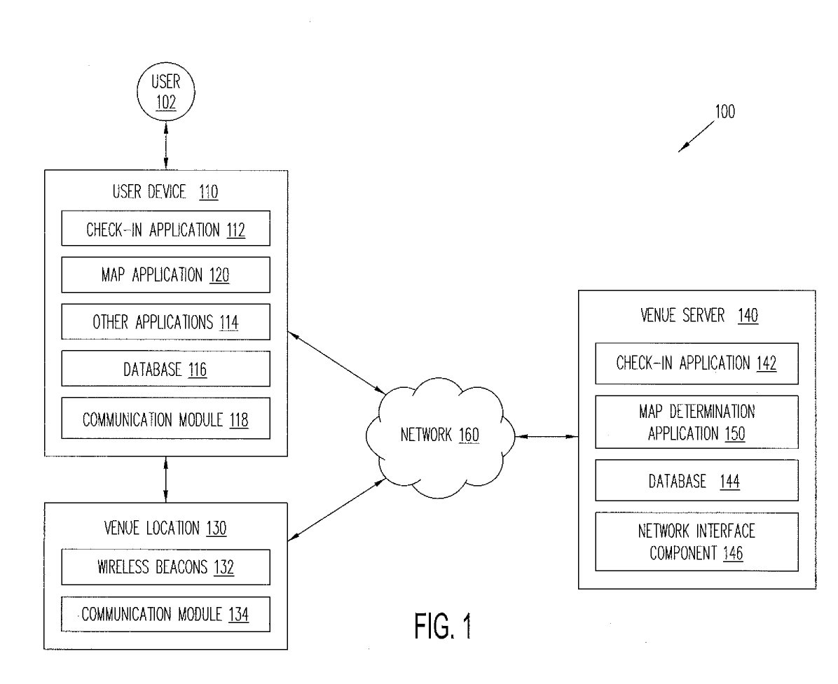

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a venue location 130, and a venue server 140 in communication over a network 160. User 102, such as a visitor at a venue location, may utilize user device 110 to check-in to venue server 140. A venue may correspond generally to any place crowds congregate. Thus, the venue may include not just amusement parks, concert halls, sports arenas, museums, etc., but also tourist locations (e.g., sightseeing locations, monuments, etc.), travel locations (e.g., airports, train stations, etc.), and similar areas. Venue server 140 may correspond to a general server for multiple venue locations (e.g. a server for a whole city with multiple tourist/sightseeing areas, a collection of amusement parks, etc.) or may be specific to only venue location 130 (e.g. a server for a specific museum, sports arena, concert hall, etc.). Check-in of user 102 may be accomplished through one of wireless beacons 132 at venue location 130. Once user 102 is checked-in to venue server 140, the user may be associated with a location corresponding to the wireless beacon that completed the check-in. Once check-in is completed for a plurality of users, venue server 140 may complete a travel route for one or more of the plurality of users to minimize a number of users at each of wireless beacons 132.

User device 110, venue location 130, and venue server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication with wireless beacons 132 and venue server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a check-in application 112, a map application 120, other applications 114, a database 116, and a communication module 118. Check-in application 112, map application 120, and other applications 114 may correspond to processes, procedures, and/or applications executable by a hardware processor, for example, a software program. In other embodiments, user device 110 may include additional or different software as required.

Check-in application 112 may be used by user 102 of user device 110 to establish a connection between user device 110 and venue server 140. Check-in application 112 may correspond to an application utilized by user device 110 with venue server 140 to complete a check-in with venue server 140. The check-in with venue server 140 may correspond to a process to log in to a user account of user 102 with venue server 140. In other embodiments, the check-in may provide and/or verify identity of user 102, including transmission of an identifier for user 102 and/or user device 110. The check-in may be completed over network 160 with venue server 140. In such embodiments, check-in application 112 may correspond more generally to a browser application configured to communicate with venue server 140.

Check-in application 112 may also correspond to an application available over the Internet for download from venue server 140 and/or other server. Check-in application 112 may be set up to receive short range wireless communications with a wireless beacon at venue location 130 to complete the check-in process. For example, venue location 130 may include infrastructure with wireless beacons 132 to communicate with user device 110 and complete the check-in process with venue server 140. Wireless beacons 132 may be configured to transmit an identifier for reception by user device 110, as will be explained in more detail herein.

Check-in application 112 may execute in the background of an operating system of user device 110 and be configured to establish connections, using communication module 118 of user device 110, with one of wireless beacons 132 at a location corresponding to user 102. The connection may be established with or without user input from user 102. For example, wireless beacon 132 may broadcast a token, such as a universally unique identifier (QUID), for reception by check-in application 112, as will be explained in more detail herein. Check-in application 112 may utilize communication module 118 of user device 110 to receive the token from wireless beacon 132. If check-in application 112 acknowledges the QUID as identifying venue location 130, wireless beacon 154, and/or venue server 140, check-in application 112 may transmit an identifier corresponding to user 102 and/or user device 110 back to wireless beacon 132. Check-in application 112 may utilize communication module 118 of user device 110 to communicate with wireless beacon 132 (e.g., over near field communication, Bluetooth, Bluetooth Low Energy, radio, infrared, or other connection). The identifier from user device 110 may include, be transmitted with, concatenated with, or otherwise bundled with the identifier received from wireless beacon 132.

Once a connection is established with one of wireless beacons 132, user device 110 may be checked-in with venue server 140 if user 102 has not previously been checked-in. The check-in process may then associate user 102 with one of wireless beacons 132 used to check-in user 102. Thus, user 102 and/or a plurality of other users may be associated with one or more of wireless beacons 132. In such embodiments, check-in application 112 may utilize short range wireless communication of user device 110 with wireless beacons 132, such as near field communication, Bluetooth, Bluetooth Low Energy, radio, infrared, or other connection.

Check-in application 112 may receive information from venue server 140. For example, check-in application 112 may receive maps, travel routes, updates, user traffic/travel patterns, prerecorded information about a location, and/or other information corresponding to locations within venue location 130 (e.g., venue attractions) and corresponding to wireless beacons 132. The information may be passed to check-in application 112 generally based on a location of user 102. Additionally, the information, such as the travel routes may be transmitted to user 102 based on a distance from user 102 to one or more locations, based on a user history of visited attractions (e.g. tracking user 102 through a GPS or other mapping function of user device 110, tracking check-in to each of wireless beacons 132, a transaction/purchase history of user 102, etc.), or may be generally transmitted to user 102 based on crowd congestion rates for the locations at venue location 130. Since user 102 is already checked-in with venue server 140, venue server 140 may know an identifier of user device 110 and transmit the travel route/map information to user device 110 using that identifier over network 160 and/or through one of wireless beacons 132.

Check-in application 112 may utilize communication module 118 to pass information to venue server 140, including preferences for desired visits to one or more venue attractions at venue location 130, identifiers of user 102 and/or user device 110, and/or transaction/purchase histories corresponding to venue location 130 (e.g., ticket purchases for shows at venue location 130, purchased fare for rides at venue location 130, etc.). In various embodiments, user 102 may also establish a number of users with user 102 and pass the number of users corresponding to the check-in of user device 110 to venue server 140. For example, a family at a location may correspond to 5 users; however, only one family member may possess a user device. Thus, user device 110 may instead check-in 5 users with one or wireless beacons 132. Once check-in application 112 has completed a connection with venue server 140, user device 110, and thus user 102, may receive mapping information including travel routes corresponding to venue location 130, as will be discussed in more detail herein.

Map application 120 may be used, for example, to provide a convenient interface to permit user 102 to view travel routes including maps and/or directions for visits to locations within venue location 130. Map application 120 may correspond to an application specific to venue location 130 and/or venue server 140, such as an application downloadable over network 160 and/or through wireless beacons 132. However, in other embodiments, map application 120 may correspond more generally to any application configured to display travel routes to user 102 for venue location 130, including a browser application.

Map application 120 may be configured to display a map of venue location 130 and/or some subset of venue location 130. Map application 120 may also be configured to display a travel route for user 102 corresponding to visits to locations (e.g. attractions, exhibits, etc.) in venue location 130. For example, map application 120 may display a list of locations to visit in a specific order, a list of directions to the locations, and/or a graphical overlay on the map of venue location 130 displaying a route to visit one or more locations at venue location 130. The travel route may be determined by venue server 140, as will be explained in more detail herein. Map application 120 may further identify user 102 with a user location on a displayed map. Thus, map application 120 may use a location device and/or application of user device 110, such as a GPS device and application, to locate user 102 on the map. In other embodiments, user 102 may be located on the map based on the check-in of user device 110 with one or more of wireless beacons 132. Map application 120 may also display information received from wireless beacon 132 and/or over network 170, such as audio/visual/audiovisual content for venue location 130 and/or a particular location within venue location 130. Such content may include descriptions of the locations, videos for the location, interactive games, etc.

Map application 120 may further allow user 102 to enter information for determining the travel route for venue location 130. For example, user 102 may select one or more locations that user 102 would like to visit at venue location 130. Selection may be done through typing in a name and/or identifier of the location, or may be done through selection of objects, names, or areas of a displayed map for venue location 130. Map application 120 may also receive information from user input corresponding to desired visits to locations, such as purchased tickets for an attraction, or may receive the information from one or more other applications of user device 110.

Map application 120 may be further configured to display a number of users at each location at venue location 130 having one or more of wireless beacons 132. The number of users may correspond to the number of users checked-in to one or more of wireless beacons 132 at the location, as will be explained in more detail herein. The number of users at each beacon may be updated as users leave the area and disconnect from a check in with one of wireless beacons 132, or arrive at the area and initiate a check in with one of wireless beacons 132. Map application 120 may be updated in real-time, or may be updated as certain time intervals, of the changes in users at each of one of wireless beacons 132. Additionally, venue server 140 may track user traffic, such as real-time user flow between location corresponding to one or more of wireless beacons 132, as will be explained in more detail herein. Thus, map application 120 may display user traffic throughout venue location 130

In various embodiments, check-in application 112 and map application 120 may be incorporated in the same application so as to provide their respective features in one application interface.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking, online payments, money transfer, or other applications. Other applications 114 may include browser and/or mapping applications, where the functions are not provided by check-in application 112 and/or map application 120. Other applications 114 may contain software programs, executable by a processor, including a graphical user interface (GUI) configured to provide an interface to the user.

User device 110 may further include database 116 which may include, for example, identifiers such as operating system registry entries, cookies associated with check-in application 112, map application 120, and/or other applications 114, identifiers associated with hardware of user device 110, or other appropriate identifiers, such as identifiers used for payment/user/device authentication or identification. Database 116 may include user device tokens and/or encryption keys, including a public key of venue server 140 for one or more of wireless beacons 132. Database 116 may include identifying information for tokens enabling check-in application 112 to identify one or more of wireless beacons 132 when receiving a corresponding token. In one embodiment, identifiers in database 116 may be used to associate user device 110 with a particular account maintained by the account provider. Database 116 may further include online account access information.

User device 110 includes at least one communication module 118 adapted to communicate with wireless beacon 132 and/or venue server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacon 132 without network 160 using short range wireless communications.

Venue location 130 may correspond to a physical location where crowds may congregate and cause crowd congestion. Thus, venue location 130 may correspond to amusement parks, concert halls, sports arenas, museums, etc., as well as high foot traffic areas of a city such as tourist locations, travel locations (e.g., airports, train stations, etc.), and similar areas. A plurality of locations may be located within venue location 130, where each location corresponds to one or more wireless beacon 132. For example, a location in venue location 130 may correspond to an attraction/exhibit with a wireless beacon located at the exhibit. Wireless beacons 132 may check-in user 102 when user device 110 is in proximity to wireless beacons 132. Thus, wireless beacons 132 enable venue server 140 to track a number of users at each location, as will be explained in more detail herein. Venue location 130 may be one of a plurality of locations corresponding to venue server 140. However, in other embodiments, venue server 140 may correspond only to venue location 130.

Service provider 130 includes a wireless beacon 132 and a communication module 134. In other embodiments, service provider 130 may include additional or different software and devices as required

Wireless beacon 132 may be maintained, for example, by venue location 130 and venue server 140. Wireless beacon 132 may be implemented using any appropriate hardware and software configured for wireless communication with user device 110. For example, in one embodiment, wireless beacon 132 may be implemented as a dongle device including a hardware processor and a communication module, for example, connected to device at venue location 130. Thus, wireless beacon 132 may be implemented as a device incorporated within or attached to a personal computer (PC), a smart phone, personal digital assistant (PDA), laptop computer, and/or other types of computing devices capable of transmitting and/or receiving data, such as an IPAD® from APPLE®. Wireless beacon 132 may also act as a stand-alone device including a processor, communication module, and/or network interface component configured to communicate with user device 110 and/or venue server 140. Although a plurality of wireless beacons is described, a single beacon may be utilized.

Wireless beacons 132 of FIG. 1 contain processes, procedures, and/or applications executable by a hardware processor, for example, a software program, configured to interact with user device 110. Wireless beacons 132 may include applications for transmitting requests to establish a connection between a user device and a server. Thus, wireless beacons 132 may utilize a low energy short range wireless communication of wireless beacons 132 to transmit requests to establish a connection with user device 110, including an identifier such as a UUID. If user device 110 receives one of the requests to establish the connection and responds with a user device identifier (potentially including the UUID and other information to effectuate a check-in of user device 110), the beacon of wireless beacon 132 receiving the user device identifier may ramp up in power and create a connection between user device 110 and the beacon. Wireless beacons 132 may transmit the request to establish the connection with wireless beacons 132 as a short range communication (e.g. a BLE protocol communication) including a “wake up” process for check-in application 112 of user device 110 and a token for wireless beacon 132 and/or venue server 140. The request may be specific to user device 110 by including information that is specific to user 102, such as a name, identifier, or user device identifier. Thus, in certain embodiments, only user device 110 will pick up and authenticate the request.

After one of wireless beacons 132 receives a user device identifier from user device 110, the beacon may determine user 102 is in proximity to the location correspond to the beacon. Wireless beacons 132 may pass the user device identifier to venue server 140 to complete the check-in process and associate user 102 with the location. As shown in FIG. 1, wireless beacons 132 utilizes communication module 134 to pass the information to venue server 140. However, in other embodiments, wireless beacons 132 may utilize a network connection of wireless beacons 132 using a communication module of wireless beacons 132. Additionally, wireless beacons 132 may keep a communication channel open between user device 110 and venue server 140 for passing additional information, such as transaction, payment, transportation, and/or identification information.

In various embodiments, venue location 130 includes at least one communication module 134 adapted to communicate with user device 110 and/or venue server 140 over network 160. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 134 may communicate directly with user device 110 without network 160 using short range wireless communications.

Venue server 140 may be maintained, for example, by a venue location including one or a plurality of venue locations. Generally, venue server 140 may be maintained by anyone or any entity that establishes and/or maintains a venue visited by users. In this regard, venue server 140 may include one or more applications, which may be configured to interact with user device 110 and/or venue location 130 to complete check-in processes for the users. Venue server 140 may be further configured to create a travel route for the users throughout venue location 130. Additionally, venue server 140 may transmit information about users at locations throughout venue location 130 to a user, including number of users at the location and/or traffic of the users between the locations. Although only one venue server is shown, a plurality of venue servers may be utilized. In various embodiments, the check-in and mapping features of venue server 140 may also be offered by a payment and/or service provider. Thus, the described processes and features of venue server 140 may be incorporated within another server.

Venue server 140 includes a check-in application 142, a map determination application 150, a database 144, and a network interface component 146. Check-in application 142 and map determination application 150 may correspond to processes, procedures, and/or applications executable by a hardware processor, for example, a software program. In other embodiments, venue server 140 may include additional or different software as required.

Check-in application 142 may correspond to processes to complete check-in with user device 110. Thus, check-in application 142 may correspond to the server side application of venue server 140 configured to transmit and/or receive a check-in request from user device 110 and complete the check-in request. The check-in request may include log in information for a user account in database 144 and thus complete the check-in with user 102 by verifying the account information. However, in embodiments where a user account has not been previously established by user 102 and/or venue server 140 does not offer user account services, check-in application 142 may receive other information for identifying user 102, include user name/identifier, user device identifier, an identifier for an account with another server (e.g., a payment account/payment account identifier with a payment provider server), or other information.

Once check-in is completed between user device 110 and venue server 140, check-in application 142 may be utilized to associate user 102 with a location corresponding to one of wireless beacons 132 that checked-in user 102. Check-in application 142 may check-in a plurality of other users at wireless beacons 132 corresponding to different locations, throughout venue location 130. Additionally, check-in application 142 may check user 102 out of a location when user 102 leaves the proximity of the beacon. For example, user 102 may arrive at a location and establish a connection with one of wireless beacons 132. When user 102 leaves the proximity of the beacon so that user device 110 is no longer in communication with the beacon, user 102 may be checked-out of the location, and check-in application 142 may account for a new number of users at the location.

Venue server 140 further includes map determination application 150. Map determination application 150 may be utilized to receive information corresponding to user 102 and/or a plurality of users checked-in to wireless beacons 132. Map determination application 150 may provide travel routes to user 102 and/or other users to reduce crowd congestion throughout venue location 130. In this regard, map determination application 150 may receive a number of users at locations corresponding to one or more of wireless beacons 132. The locations in venue location 130 may correspond to places where crowds congregate (e.g., an amusement park ride, attraction, exhibit, sightseeing location, etc.). Utilizing this information, map determination application 150 may determine a travel route to at least one of wireless beacons 132 for user 102 and transmit the travel route to user 102. The travel route may be determined to minimize a number of users at each of wireless beacons 132, thus reducing crowd congestion at locations throughout venue location 130. The travel route may include a list of direction to each of wireless beacons 132, as well as a graphical overlay for a map on user device 110 so user 102 may view a graphical display of the travel route. Map determination application 150 may also determine audio/visual/audiovisual content to transmit for display to user 102, include content directed to a particular location user 102 is near or will visit at venue location 130.

Map determination application 150 of venue server 140 may transmit the travel route to the first user. Additionally, map determination application 150 may transmit a number of users at one or more of wireless beacons 132 to user device 110. The number of users at wireless beacons 132 may also be updated as users move from beacon to beacon. Thus, map determination application 150 may transmit changes to the number of users at wireless beacons 132 in real time or at specific intervals. Moreover, the change in the number of users at wireless beacons 132 may be utilized to determine user traffic corresponding to a flow of users to and from each of wireless beacons 132. Map determination application 150 may update user device 110 with the user traffic and/or determine the travel route using the user traffic.

The number of users at the locations in venue location 130 may also be utilized by map determination application 150 to determine a wait time at each of the locations corresponding wireless beacons 132 and/or an amount of time user 102 should spend at a visited location. For example, map determination application 150 may determine an expected wait time of 30 minutes for an amusement park ride. In another embodiment, map determination application 150 also determine that user 102 should spend 15 minutes viewing an exhibit to reduce crowd congestion and/or be able to view all locations on the travel route. The expected wait times and time to spend at each location may be transmitted to user device 110 by map determination application 150.

Map determination application 150 may receive user preferences corresponding to places user 102 would like to visit. The user preferences may be a selection of locations in venue location 130 to visit, or may be determined from other user input, including purchased tickets to shows in venue location 130, ages and/or interests of user 102 and/or other users with user 102 (e.g., family member ages and interests), or other preference information. Map determination application 150 may utilize the user preferences to determine the travel route.

Venue server 140 further includes database 144 which may include, for example, identifiers such as operating system registry entries, identifiers associated with hardware of venue server 140, or other appropriate identifiers, such as identifiers used for user/device authentication or identification. Database 144 may include user accounts of user 102, which may comprise user personal information, user financial information, and/or an identifier for user 102 and/or user device 110. In various embodiments, identifiers in database 144 may be used by a payment/credit provider to associate user 102 with a particular account maintained by the payment/credit provider. For example, an identifier for a payment account with a payment provider server may be stored with a user account or identifier of user 102 in database 144. In other embodiments, a user account stored in database 144 may include a shared identifier with another account.

In various embodiments, venue server 140 includes at least one network interface component 146 adapted to communicate with user device 110 and/or venue location 130 over network 160. In various embodiments, network interface component 146 may include a DSL (e.g., Digital Subscriber Line) modem, a PSTN (Public Switched Telephone Network) modern, an Ethernet device, a broadband device, a satellite device and/or various other types of wired and/or wireless network communication devices including microwave, radio frequency, infrared, Bluetooth, and near field communication devices

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

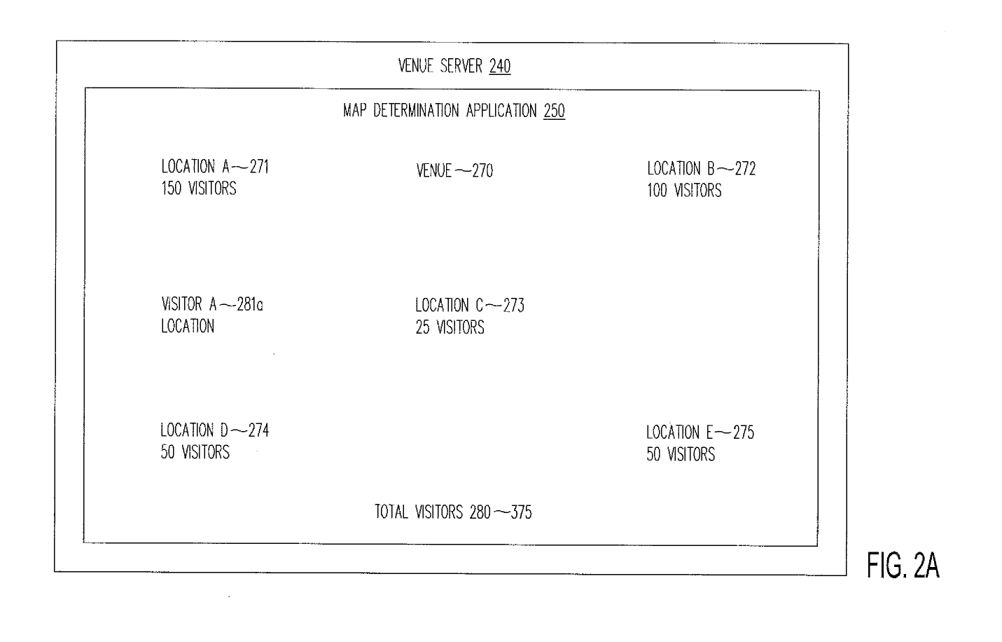

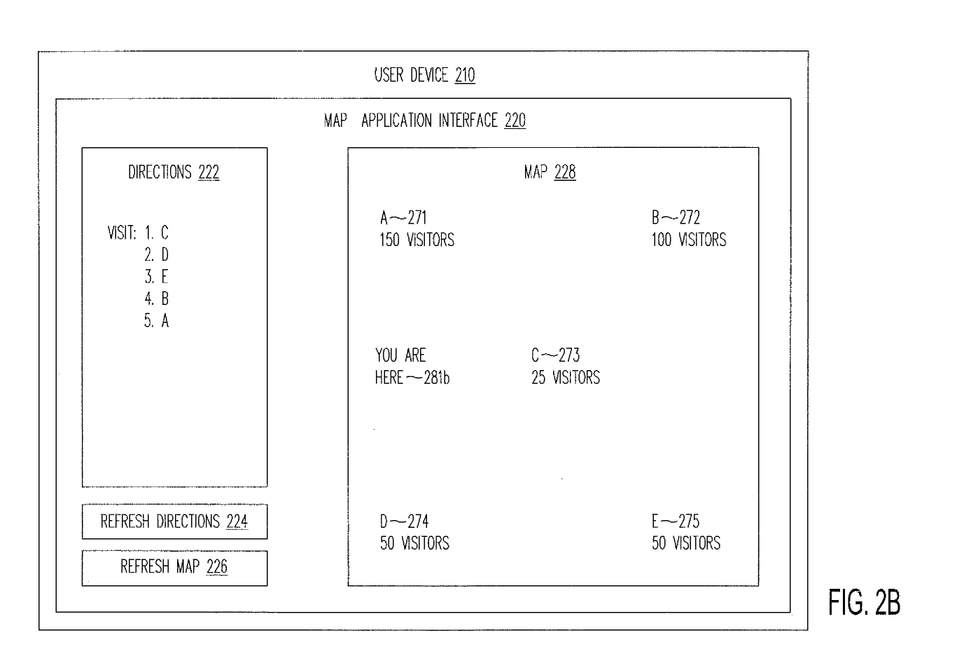

FIG. 2A is an exemplary venue server including map information for a venue location, according to an embodiment. FIG. 2A includes a venue server 240 and a map determination application 250 corresponding generally to venue server 140 and map determination application 150, respectively, of FIG. 1.

FIG. 2A displays exemplary venue and crowd information (e.g., data corresponding to a venue and users at the venue) used to determine a travel route for a user at a venue. As previously discussed, venue server 240 may correspond to one or a plurality of venues. Each venue may include a plurality of beacons spread throughout the venue, so that locations of interest to users visiting the venue have a beacon nearby. The beacons are utilized to establish a check-in for a wireless device of a user in proximity to the beacon.

Map determination application 250 may therefore include a representation of a venue 270. The representation of venue 270 in FIG. 2A includes a map of venue 270. In other embodiments, map determination application 250 may include additional or different data corresponding to venue 270, such as distance between beacons/locations in venue 270, required time to view on of the locations in venue 270 (e.g. a show time), costs to view a location, and/or other information corresponding to locations in venue 270.

As shown in FIG. 2A, venue 270 includes a location A 271, a location B 272, a location C 273, a location D 274, a location E 275, and a visitor A location 281a. Each of location A 271-location E 275 may correspond to locations in venue 270 where crowds congregate. Additionally, each of location A 271-location E 275 may include one or more wireless beacons corresponding to the location and configured to complete a check-in with a user device of a user in proximity of the location. Thus, each of location A 271-location E 275 include a number of users checked-in to each location. Visitor A location 281a further corresponds to a location of a visitor A for use in determining a travel route for visitor A. Map determination application 250 further includes a total visitors 280 corresponding to a total number of users at venue 270.

Using information for location A 271-location E 275, visitor A location 281, and/or total visitors 280, map determination application 250 may determine a travel route for visitor A while in venue 270. For example, location A 271 includes 150 visitors (users at the park checked-in at the beacon for location A 271), location B 272 includes 100 visitors, location C 273 includes 25 visitors, location D 274 includes 50 visitors, and location E 275 includes 50 visitors. Map determination application 250 may then determine location C 273 is the best location for visitor A to first attend based on the low number of visitors (25 visitors) checked-in to location C 273 comparative to location A 271, location B 272, location D 274, and location E 275.

Map determination application 250 may determine location C 273 is the best location for visitor A to attend based on the number of visitors at location C 273, as well as the distance to location C 273 from visitor A location 281A, a preference from visitor A to visit location C 273, traffic flow patterns of visitors going to and from location A 271-location E 275, or other information. When determining location C 273 as the best location for visitor A to visit, map determination application 250 may utilize an algorithm with some or all of the aforementioned information. Each information parameter previously described may be applied a different weight in the algorithm, which may be configurable by visitor A, in various embodiments.

Map determination application 250 may also determine a travel route to the rest of location A 271, location B 272, location D 274, and location E 275 from location C 273. Based on the 50 visitors at location D 274 and location E 275, map determination application 250 may determine visitor A should visit location D 274 or location E 275. Again, user preferences, changes to users at location D 274 and/or location E 275, user traffic throughout venue 270, or other information may affect the choice to send visitor A to location D 274 or location E 275. Additionally, map determination application 250 may determine a most efficient route based on total travel time and/or distance between all of location A 271-location E 275. For example, map determination application may send visitor A to location D 274 after location C 275, then to location E 275, and then to location B 272 to minimize a travel time and/or distance for visitor A between the locations. As previously discussed, user preferences, changes in visitors at location A 271-location E 275, traffic flow throughout venue 270, or other information parameters may affect the determination of the travel route.

In one embodiment, in order to minimize a travel time and/or distance, map determination application 250 may send visitor A from visitor A location 281a to location C 273 first, location D 274 second, location E 275 third, location B 272 fourth, and location A 271 last. In such an embodiment, map determination application 250 determines visitor A will spend the least amount of time at location C 273 first and thus as visitors leave location A 271, location B 272, location D 274, and location E 275, visitor A has a higher likelihood of spending less time at location A 271, location B 272, location D 274, and location E 275 and thus may cause less crowd congestion. In this embodiment, map determination application 250 determines visitor A would like to see all of the location A 271-location E 275. As previously discussed, map determination application 250 may change, edit, or create a different travel route based on user preferences, changes in users at location A 271-location E 275, and/or user traffic. The changes may also be updated in real time or at specific intervals. For example, while visitor A is at location. C 273, all 150 visitors from location A 271 may move to location D 274, while only 25 visitors from location D 274 move to location A 271. Thus, map determination application 250 may determine visitor A should next visit location A 271 while only 25 visitors are at location A 271.

FIG. 2B is an exemplary user device displaying a travel route and map for a venue location, according to an embodiment. FIG. 2A includes a user device 210 and a map application interface 220 corresponding generally to user device 110 and map application 220, respectively, of FIG. 1.

FIG. 2B displays map application interface 220 of user device 210 showing directions 222 and a map 228 corresponding generally to a determined travel route from venue server 240 FIG. 2B. Directions 222 may correspond to directions to each of location A 271-location E 275 based on the determined travel route. Although not shown in FIG. 2B, directions 222 may include additional information, including time of wait at each of location A 271-location E 275, time to spend visiting each of location A 271-location. E 275, rate of increase or decrease of visitors at each of location A 271-location E 275, number of visitors at each of location A 271-location E 275, traffic flow between each of location A 271-location E 275, or other information. A user of user device 210, such as visitor A of FIG. 2A, may utilize a refresh directions button 224 to receive updates to directions 222 based on changes to visitors at the venue corresponding to map 228. In other embodiments, updates to directions 222 may be pushed to user device 210 by a server.

Map application interface 220 includes map 228, which may correspond generally to a displayable map of venue 270 from FIG. 2A. Map 228 includes location A 271-location E 275 as well as a signifier for a location for visitor A, such as “you are here” icon 281b. Icon 281b may be determined from user check-in with a beacon at the venue. In other embodiments, icon 281b may also be determined through a user location determining component and/or application of user device 210, such as a GPS component and application.

Map 228 includes a number of visitors at each of location A 271-location E 275. Visitor A may utilize the number of visitors with directions 222 and map 228 to travel throughout the venue. Visitor A may follow directions 222 and visit C 273 first, or may deviate from directions 222 based on preferences to visit certain locations at the venue or information presented in map 228 (e.g., wait times, crowd sizes, etc.). In various embodiments, map 228 may also display time of wait at each of location A 271-location E 275, time to spend visiting each of location A 271-location E 275, rate of increase or decrease of visitors at each of location A 271-location E 275, number of visitors at each of location A 271-location E 275, traffic flow between each of location A 271-location E 275, or other information similar to directions 222. Additionally, map application interlace 220 includes a refresh map button 226 to receive updates to map 228. In other embodiments, the updates to map 228 may be pushed to user device 210 by a server.

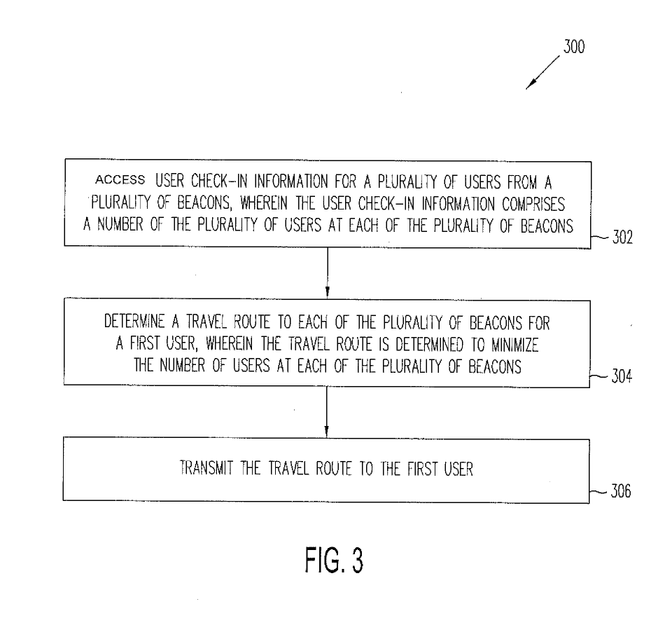

FIG. 3 is a flowchart of an exemplary process by a server for reducing crowd congestion at venue locations, according to an embodiment. Note that one or more steps, processes, and methods described herein may be omitted, performed in a different sequence, or combined as desired or appropriate.

At step 302, user check-in information for a plurality of user is received from a plurality of beacons, wherein the user check-in information comprises a number of the plurality of users at each of the plurality of beacons. A user device may check-in and communicate with the plurality of beacons using one of near field communication, radio communication, infrared communication, Bluetooth communication, and Bluetooth low energy communication. A user device may correspond to each of the plurality of users and complete the check-in process with the beacons. In various embodiments, the user device may correspond to a group of users, such as a family, and be configured to complete check-in for the group of users.

A travel route to each of the plurality of beacons is determined for a first user, at step 304, wherein the travel route is determined to minimize the number of users at each of the plurality of beacons. The travel route may comprise a list of directions to the each of the plurality of beacons. The list of directions may further comprise at least one of an expected wait time at the each of the plurality of beacons and a time to spend the each of the plurality of beacons.

In various embodiments where the beacons correspond to attractions at venue locations, the first user may transmit user preferences comprising desired visits to the attractions. The travel route may be further determined using the user preferences. Additionally, user traffic comprising real-time user flow for the plurality of users between each of the plurality of beacons may be determined. The travel route may be further determined using the user traffic.

At step 306, the travel route is transmitted to the first user. The first number of the plurality of users at each of the plurality of beacons may also be transmitted to the first user. The first user may receive updates to the first number of the plurality of users at each of the plurality of beacons after determining a second number of the plurality of users at each of the plurality of beacons.

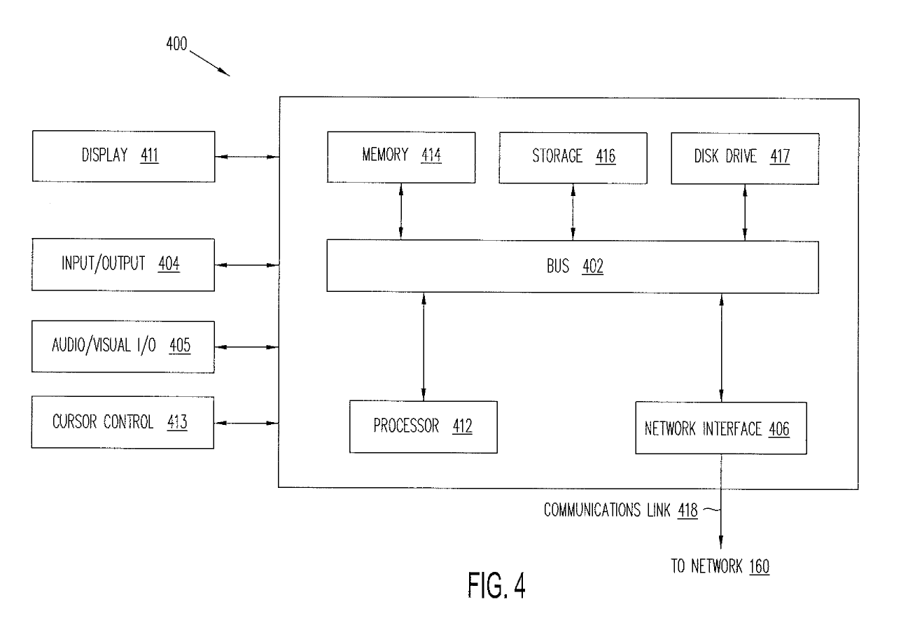

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a service provider server via network 160. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing venue information comprising venue locations for each of a plurality of beacons; and
one or more hardware processors in communication with the non-transitory memory and configured to:
access user check-in information for a plurality of users from the plurality of beacons, wherein the user check-in information comprises a first number of the plurality of users at the each of the plurality of beacons;
determine a travel route to at least one of the plurality of beacons for a first user, wherein the travel route is determined to minimize the first number of users at the each of the plurality of beacons; and
transmit the travel route to the first user.

2. The system of claim 1, wherein a user device corresponding to each of the plurality of users and the plurality of beacons communicate using one of near field communication, radio communication, infrared communication, Bluetooth communication, and Bluetooth low energy communication.

3. The system of claim 1, wherein the travel route comprises a list of directions to the each of the plurality of beacons.

4. The system of claim 3, wherein the list of directions comprises at least one of an expected wait time at the each of the plurality of beacons and a time to spend the each of the plurality of beacons.

5. The system of claim 1, wherein the plurality of beacons correspond to attractions at the venue locations.

6. The system of claim 5, wherein the one or more hardware processors is further configured to:
receive user preferences comprising desired visits to the attractions,
wherein the one or more hardware processors is further configured to determine the travel route using the user preferences.

7. The system of claim 1, wherein the one or more hardware processors is further configured to:
transmit the first number of the plurality of users at the each of the plurality of beacons to the first user.

8. The system of claim 7, wherein the one or more hardware processors is further configured to:
access a second number of the plurality of users at the each of the plurality of beacons; and
update the first user with the second number of the plurality of users.

9. The system of claim 1, wherein the one or more hardware processors is further configured to:
determine user traffic comprising the plurality of users arriving at or leaving the venue locations for the each of the plurality of beacons.

10. The system of claim 9, wherein the one or more hardware processors is further configured to determine the travel route using the user traffic.

11. A method comprising:
accessing user check-in information for a plurality of users from a plurality of beacons, wherein the user check-in information comprises a first number of the plurality of users at each of the plurality of beacons;
determining, using one or more hardware processors of a server, a travel route to at least one of the plurality of beacons for a first user, wherein the travel route is determined to minimize the first number of users at the each of the plurality of beacons; and
transmitting the travel route to the first user.

12. The method of claim 11, wherein the travel route comprises a list of directions to the each of the plurality of beacons.

13. The method of claim 12, wherein the list of directions comprises at least one of an expected wait time at the each of the plurality of beacons and a time to spend the each of the plurality of beacons.

14. The method of claim 11, wherein the plurality of beacons correspond to attractions at the venue locations.

15. The method of claim 14 further comprising:
receiving user preferences comprising desired visits to the attractions at that venue,
wherein the one or more hardware processors is further configured to determine the travel route using the user preferences.

16. The method of claim 11 further comprising:
transmitting the first number of the plurality of users at the each of the plurality of beacons to the first user.

17. The method of claim 16 further comprising:
accessing a second number of the plurality of users at the each of the plurality of beacons; and
updating the first user with the second number of the plurality of users.

18. The method of claim 11 further comprising:
determining user traffic comprising the plurality of users arriving at or leaving the venue locations for the each of the plurality of beacons.

19. The method of claim 18, wherein the one or more hardware processors is further configured to determine the travel route using the user traffic.

20. A non-transitory computer readable medium comprising a plurality of machine-readable instructions which when executed by one or more processors of a server are adapted to cause the server to perform a method comprising:
accessing user check-in information for a plurality of users from a plurality of beacons, wherein the user check-in information comprises a first number of the plurality of users at each of the plurality of beacons;
determining a travel route to at least one of the plurality of beacons for a first user, wherein the travel route is determined to minimize the first number of users at the each of the plurality of beacons;
transmitting the travel route and the first number of the plurality of users at the each of the plurality of beacons to the first user;
accessing a second number of the plurality of users at the each of the plurality of beacons; and
updating the first user and the travel route with the second number of the plurality of users.
